(19) United States
(12) Patent Application Publication
(10) Pub. No.: US 2025/0162465 A1
(43) Pub. Date: May 22, 2025

(54) ADAPTIVE POWER MANAGEMENT SYSTEM FOR FUEL CELL ELECTRIC VEHICLES

(71) Applicant: HYZON MOTORS USA INC., Bolingbrook, IL (US)

(72) Inventors: Mark Michelotti, Buffalo Grove, IL (US); Mark Murphy, Wheaton, IL (US)

(21) Appl. No.: 18/950,500

(22) Filed: Nov. 18, 2024

Related U.S. Application Data
(60) Provisional application No. 63/600,051, filed on Nov. 17, 2023.

(51) Int. Cl. B60L 58/30; B60L 50/75; B60L 58/12

(52) U.S. Cl. CPC B60L 58/30; B60L 50/75; B60L 58/12

(57) ABSTRACT

Methods for adaptive derating fuel cell electric vehicles (FCEVs) based on battery state of charge (SOC) are provided. The method calculates target battery current based on SOC, measures actual current, determines current error, and implements performance derating. This adaptive approach maintains SOC while preserving drivability, particularly for heavy transport. A vehicle control unit implements feedback control, producing a unitless derate factor between zero and one to modify vehicle performance parameters. The technology addresses challenges in scenarios like a trailer loaded outside predetermined parameters, uphill climbs, highway operation, urban delivery, and cold weather. By adaptively adjusting performance based on real-time measurements, the method optimizes power management, prevents rapid SOC depletion, and ensures operational capability in adverse conditions.

### CROSS REFERENCE TO RELATED APPLICATIONS

This application claims the benefit of U.S. Provisional Application No. 63/600,051, filed on Nov. 17, 2023. The entire disclosure of the above application is incorporated herein by reference.

### FIELD

The present technology relates to methods and systems for managing fuel cell power and battery state-of-charge in fuel cell electric vehicles (FCEVs), particularly in situations where the vehicle is operating under high load conditions or beyond its rated parameters.

### INTRODUCTION

This section provides background information related to the present disclosure which is not necessarily prior art.

Fuel cell electric vehicles (FCEVs) have emerged as a promising technology in the pursuit of zero-emission transportation. These vehicles utilize a fuel cell, often in combination with a battery, to power an onboard electric motor. FCEVs generate electricity using oxygen from ambient air and hydrogen stored onboard, emitting only water vapor and heat as byproducts.

FCEVs face certain challenges, particularly in heavy transport applications. One limitation relates to the power production capability of the fuel cell power plant. When an FCEV is operated beyond its rated parameters, such as when operating with a trailer loaded outside predetermined parameters or where the FCEV exceeds a certain speed, the fuel cell may struggle to meet the increased power demand. As a result, the high voltage battery can drain to an undesirably low level.

Power management issues therefore present a complex control problem. When the battery's state-of-charge (SOC) drops below a certain threshold, for example around 10-15%, the discharge capability of the battery may no longer support the transient demands of the FCEV. This situation can effectively strand the FCEV, rendering it inoperable until a sufficient SOC is recovered in the battery.

Current strategies to address power management issues can involve implementing a deliberate reduction in available motor traction torque, a process known as “derating.” This approach aims to prevent further depletion of the battery's SOC by lowering the vehicle's rated power and torque. However, this solution comes at the cost of reduced vehicle movement and performance. Existing derating strategies, including torque-based, power-based, and speed-based derates, can be designed as responses to fault conditions or use outside of predetermined parameters. They may not adequately address the unique situations faced by heavy transport FCEVs, which may be loaded outside predetermined parameters in the normal course of use and require more power than initially expected or scheduled.

Accordingly, there is a continuing need for more sophisticated and adaptive methods to manage fuel cell power and battery state-of-charge in FCEVs, particularly in heavy transport applications. Desirably, such methods would maintain a minimum battery SOC while preserving vehicle drivability to the greatest extent possible, avoiding situations where the vehicle becomes immobilized due to power management issues.

### SUMMARY

In concordance with the instant disclosure, more sophisticated and adaptive methods to manage fuel cell power and battery state-of-charge in fuel cell electric vehicles, particularly in heavy transport applications has surprisingly been discovered. The present technology includes articles of manufacture, systems, and processes that relate to adaptive ways to accomplish a derating goal. The present technology may reduce available power by only an amount sufficient to maintain a target state of charge. As such, power is reduced less, and power is returned more quickly to the fuel cell electric vehicle.

In certain embodiments, a method of adaptively derating a fuel cell electric vehicle can include calculating a target battery current based on the state of charge of a battery in the fuel cell electric vehicle. The target battery current can be calculated using a linear function of the state of charge or through a lookup table. The method can include measuring an actual battery current of the battery using sensors integrated into the power management system of the fuel cell electric vehicle. A battery current error can be determined based on a difference between the target battery current and the actual battery current. The battery current error can be calculated using a simple subtraction of the actual battery current from the target battery current. The method can include implementing a performance derating for the fuel cell electric vehicle based on the battery current error through a feedback control mechanism. The performance derating can be implemented using a unitless derate factor limited between zero and one to modify vehicle performance parameters.

In certain embodiments, a system for adaptively derating a fuel cell electric vehicle can include the fuel cell electric vehicle with a battery and a vehicle control unit. The vehicle control unit can be configured to calculate a target battery current based on the state of charge of the battery. The target battery current can be determined using either a linear function of the state of charge or through a lookup table approach. The vehicle control unit can be configured to measure an actual battery current of the battery using sensors that are integrated into the power management system. These sensors can continuously monitor the flow of current into and out of the battery, providing real-time data on the charging and discharging status. The vehicle control unit can be configured to determine a battery current error based on a difference between the target battery current and the actual battery current. This battery current error can be calculated using a simple subtraction of the actual battery current from the target battery current. The vehicle control unit can be configured to implement a performance derating for the fuel cell electric vehicle based on the battery current error through a feedback control mechanism. The performance derating can be implemented using a unitless derate factor that can be limited between zero and one to modify vehicle performance parameters such as maximum permitted tractive power, tractive current, and tractive torque.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic depiction of a system for derating a fuel cell electric vehicle, according to an embodiment of the present disclosure.

FIG. 2 is a flowchart illustrating a method of adaptively derating a fuel cell electric vehicle, according to an embodiment of the present disclosure.

FIG. 3A is a schematic depiction of a static derate operation for a fuel cell electric vehicle, according to an embodiment of the present disclosure.

FIG. 3B is a schematic depiction of a adaptive derate operation for a fuel cell electric vehicle, according to an embodiment of the present disclosure.

FIG. 4 is graphical depiction of adaptive power data for non-adaptive derating of a fuel cell electric vehicle, according to an embodiment of the present disclosure.

FIG. 5 is graphical depiction of adaptive power data for a adaptive derating of a fuel cell electric vehicle, according to an embodiment of the present disclosure.

FIG. 6 is graphical depiction of adaptive trial data for a non-adaptive fuel cell electric vehicle derating, according to an embodiment of the present disclosure.

FIG. 7 is graphical depiction of dynamic trial data for a adaptive fuel cell electric vehicle derating, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one clement or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves control of a fuel cell and a battery in a fuel cell electric vehicle (FCEV) by implementing an adaptive performance derating method. The method enhances the management of power output and the state-of-charge (SOC) of the battery in FCEVs, particularly in heavy transport applications where vehicles may be loaded outside predetermined parameters during normal use. Unlike static derating approaches, the present technology reduces available power only by the amount necessary to maintain a target SOC, resulting in less power reduction and quicker power return to the battery. This adaptive approach allows for more efficient and continuous operation of the FCEV while prolonging the longevity of its components.

The present technology may include an adaptive method to accomplish a derating goal, in contrast with a static derate. Derating refers to a deliberate reduction in available motor traction torque or power output in a fuel cell electric vehicle to militate against further depletion of the state-of-charge of the battery when it drops below a certain threshold. This process effectively lowers the vehicle's rated power and torque to maintain a minimum battery SOC, albeit at the expense of reduced vehicle movement and performance. In the context of FCEVs, derating can be implemented as a response to situations where the fuel cell cannot keep up with the power demand, such as when the vehicle is operated beyond its rated parameters (e.g., carrying a trailer loaded outside predetermined parameters or where the FCEV exceeds a certain speed), which can result in the high voltage battery draining to an undesirably low level.

Derating strategies can include torque-based derate, power-based derate, and speed-based derate. These strategies can be designed as responses to fault conditions or operation outside predetermined parameters. However, they may not adequately address the unique situations faced by heavy transport FCEVs, which may require more power than initially expected or scheduled during normal operations. The present technology aims to improve upon these derating methods by implementing an adaptive, adaptive derating approach. This method reduces available power only by the amount necessary to maintain a target SOC, resulting in less power reduction and quicker power return to the battery compared to static derating approaches.

A fuel cell electric vehicle (FCEV) can include several components that enable the implementation of the adaptive derating method. The FCEV can include a fuel cell power plant, which can serve as the primary power source, generating electricity through the electrochemical reaction between hydrogen and oxygen. The FCEV can also include a high voltage battery, which can function as an additional power source and energy storage system. The state-of-charge (SOC) of the battery can be an important parameter that the method aims to manage and maintain. An electric motor can be present in the FCEV, converting the electrical energy from the fuel cell and battery into mechanical energy to propel the vehicle. The FCEV can also incorporate a hydrogen storage system to store the hydrogen fuel used by the fuel cell to generate electricity.

A component for implementing the method can be the vehicle control unit (VCU). The VCU can be responsible for calculating the target battery current, measuring the actual battery current, determining the battery current error, and implementing the performance derating based on these calculations. The FCEV can also be equipped with various sensors to monitor the state-of-charge of the battery, actual battery current, and other relevant parameters. Power electronics can also be included to manage the power flow between the fuel cell, battery, and electric motor, and can be crucial in implementing the adaptive derating strategy. An onboard computer system can be present to run the control software that implements the adaptive derating algorithm, including the feedback control and calculation of the unitless derate factor.

The method for adaptively derating a FCEV based on the SOC of the battery can aim to maintain battery SOC at or above a predetermined level while preserving vehicle drivability to the greatest extent possible. This adaptive approach can allow for more efficient power management in FCEVs, particularly in heavy transport applications where vehicles can be loaded outside predetermined parameters during normal use.

The first step of the method can involve calculating a target battery current based on the SOC of the battery. The first step of calculating a target battery current based on the SOC of the battery can be implemented using different approaches to determine the ideal battery current that would maintain or achieve the desired SOC. Two main approaches are described: a linear function and a lookup table.

A linear function approach can use a direct proportional relationship between the target current and the difference between the current SOC and the desired SOC such that as the SOC deviates further from the desired level, the target current can increase or decrease linearly. For example, if the current SOC is lower than desired, the target current can be set to charge the battery at a rate proportional to how far below the desired SOC it is. Implementation of a linear function can involve an equation such as: Target Current=K*(Desired SOC−Current SOC), where K is a constant that determines how aggressively the system responds to SOC deviations.

Alternatively, a lookup table can be used, which can offer more flexibility in tuning the relationship between SOC and target current. A lookup table can be a pre-defined set of values that maps specific SOC levels to corresponding target currents or derate factors. The lookup table can allow for a more nuanced power management strategy, as it can account for non-linear relationships between SOC and desired current. Implementation of a lookup table can involve creating a data structure (such as an array or database) that stores pairs of SOC values and their corresponding target currents or derate factors. The system can then reference this table to determine the appropriate target current based on the current SOC. The lookup table approach can be particularly useful for accommodating complex relationships between SOC and target current that may not be easily represented by a simple linear function. It can allow for fine-tuning of the power management strategy based on factors such as battery characteristics, vehicle performance requirements, and specific use cases (e.g., heavy transport applications).

Both the linear function approach and the lookup table approach can be implemented in the vehicle control unit software. The choice between a linear function and a lookup table can depend on factors such as the complexity of the desired power management strategy, computational resources available in the VCU, and the need for flexibility in tuning the response by the system to different SOC levels.

The second step can involve measuring the actual battery current of the battery. The measurement can be performed using sensors that are integrated into the power management system of the FCEV. The sensors can continuously monitor the flow of current into and out of the battery, providing real-time data on the charging and discharging status of the battery. The sensors used for this purpose can include Hall effect sensors or shunt resistors. Hall effect sensors can measure the magnetic field generated by the current flowing through a conductor, while shunt resistors can measure the voltage drop across a known resistance to determine the current. Both types of sensors can provide accurate measurements of high currents without introducing significant power losses.

To ensure the accuracy and stability of the current readings, a low-pass filtering technique can be applied to the battery current signal. Low-pass filtering can include signal processing that allows low-frequency signals to pass through while attenuating high-frequency signals. In the context of battery current measurement, low-pass filtering can help to reduce electrical noise and sudden fluctuations that might occur due to rapid changes in power demand or electromagnetic interference.

The implementation of low-pass filtering can involve using hardware filters, such as resistor-capacitor (RC) circuits, or digital filtering algorithms in the vehicle control unit software. Digital filtering can offer more flexibility and can be easily adjusted through software updates. Common digital low-pass filter implementations can include moving average filters, Butterworth filters, or Kalman filters. By applying low-pass filtering, the system can obtain a smoother, more stable representation of the battery current. This filtered signal can provide a more reliable input for the subsequent steps of the adaptive derating method, reducing the likelihood of unnecessary or erratic derating actions based on transient current spikes or noise.

The third step can involve determining a battery current error based on the difference between the target battery current and the actual battery current. The battery current error can be calculated using a subtraction: Battery Current Error=Target Battery Current-Actual Battery Current. The calculation of the battery current error can be performed by the vehicle control unit as part of its ongoing power management calculations.

The error value can provide a quantitative measure of how far the actual battery usage deviates from the ideal usage that would maintain the desired state of charge. A positive error can indicate that the battery is being discharged more slowly than desired or charged more quickly than needed, while a negative error can indicate the opposite. The magnitude of the battery current error can be used for determining the extent of derating required to optimize power management in the FCEV. A larger error can suggest a greater deviation from the desired operating conditions, potentially necessitating more significant derating. Conversely, a smaller error can indicate that the system is operating closer to the ideal conditions, possibly requiring less aggressive derating. The error value can serve as an input for the adaptive derating process in the subsequent step. By continuously monitoring and responding to this error, the power management system can make real-time adjustments to maintain the SOC of the battery within the desired range while maximizing vehicle performance.

Another step of the method can involve implementing performance derating for the FCEV based on the battery current error, which can be achieved through a feedback control mechanism that can operate on the battery current error. The feedback control can be implemented using various approaches, such as a proportional-integral-derivative (PID) controller, a sliding mode feedback control, or an optimal feedback control. A proportional-integral-derivative (PID) controller can adjust the derating based on the current error (proportional term), accumulated error over time (integral term), and rate of change of the error (derivative term). This allows the system to respond both to immediate battery current deviations as well as longer-term trends. A sliding mode feedback control can provide robust control by forcing the system state to follow a prescribed path or “sliding surface,” which can help maintain the battery state of charge within desired bounds despite uncertainties or disturbances in the system. An optimal feedback control can minimize a specific performance criterion while maintaining the battery state of charge, potentially balancing multiple objectives like maximizing vehicle performance while protecting battery health.

The feedback control mechanism, regardless of which approach is used, operates on the battery current error to produce a unitless derate factor between zero and one. This derate factor is then used to modify vehicle performance parameters like maximum permitted tractive power, tractive current, and tractive torque.

The control gains in these feedback systems can be selected to achieve the desired state of charge profile as the battery approaches minimum state of charge. The control gains can determine how aggressively the system responds to deviations from the target battery current. The selection of appropriate gains can be important for balancing the competing needs of maintaining battery SOC and preserving vehicle performance.

The output of this feedback control can typically be a unitless derate factor, which can be limited between zero and one. A factor of zero can represent no derating (full performance), while a factor of one can represent maximum derating (minimum performance). The derate factor can then be used to modify various vehicle performance parameters. For example, the derate factor can be applied to maximum permitted tractive power, tractive current, and tractive torque. By multiplying these parameters by the derate factor, the system can produce a final permitted tractive power, final tractive current, and final tractive torque. This approach can allow for a smooth and continuous adjustment of vehicle performance based on the battery state of charge and current usage. The implementation of this feedback control and derating strategy can typically be performed by the vehicle control unit (VCU) as part of ongoing power management calculations. For example, if the derate factor is 0.8 due to a lower battery SOC, and the maximum permitted tractive power is 100 kW, the final permitted tractive power would be reduced to 80 kW (100 kW×0.8). This reduction helps manage power consumption and maintain the battery's SOC while still allowing the vehicle to operate, albeit at a reduced performance level.

The adaptive derating method for fuel cell electric vehicles (FCEVs) can be applied in various scenarios, particularly in heavy transport applications where vehicles may face challenging operating conditions. These applications demonstrate the method's adaptability and effectiveness in managing power consumption while maintaining vehicle drivability. The following examples illustrate how the method can be implemented in different situations commonly encountered by FCEVs, showcasing its ability to optimize performance and preserve battery state of charge (SOC) across diverse operational contexts.

### Trailer Loaded Outside Predetermined Parameters

When an FCEV is carrying a load beyond a predetermined capacity, the adaptive derating method can help manage power output while maintaining progress. As the battery state of charge (SOC) decreases due to the increased power demand, the method can calculate a target battery current based on the SOC. The system can then measure the actual battery current and determine the error. Based on this error, the performance derating can be implemented, gradually reducing available power to maintain the SOC while still allowing the vehicle to move, albeit at a reduced speed.

### Extended Uphill Climb

During long uphill climbs that may rapidly drain the battery, the method can be particularly useful. As the FCEV ascends, the power demand increases, potentially causing a quick drop in SOC. The adaptive derating method can continuously adjust the available power based on the calculated battery current error. This can help ensure the vehicle reaches the top of the incline without completely depleting the battery, by gradually reducing power output as needed.

### High-Speed Highway Operation

When an FCEV is operating at high speeds for extended periods, the method can help to effectively manage power consumption. The system can calculate the target battery current based on the SOC and compare it to the actual current draw. If the error indicates excessive battery drain, the method can implement a gradual derating of performance. This can allow the vehicle to maintain a reasonable cruising speed while preventing rapid SOC depletion.

### Stop-and-Go Urban Delivery

In urban environments where heavy transport FCEVs may encounter frequent stops and starts, the method can help optimize power management. During acceleration, which typically demands high power, the system can calculate the target current and measure the actual current draw. If the error suggests rapid SOC depletion, the method can implement a performance derating to limit acceleration rates, thus preserving battery charge for the entire route.

### Cold Weather Operation

In cold climates, fuel cell efficiency may decrease, potentially leading to increased reliance on the battery. The adaptive derating method can help manage this scenario by continuously monitoring the battery current error and implementing appropriate performance adjustments. This can help maintain adequate SOC even when the fuel cell is operating at reduced efficiency due to low temperatures.

In all these examples, the adaptive approach of the present technology allows for more efficient power management compared to static derating strategies. By adaptively adjusting performance based on real-time battery current measurements and SOC, the method can help maintain vehicle drivability to the greatest extent possible while preserving battery health in challenging heavy transport applications.

### Examples

Example embodiments of the present technology are provided with reference to the several figures enclosed herewith.

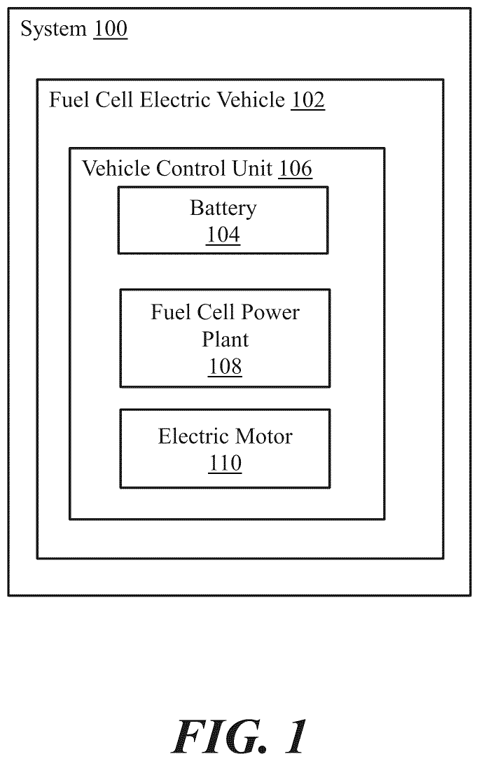

FIG. 1 is a schematic describing a system 100 for adaptively derating a fuel cell electric vehicle 102 based on a state of charge of a battery 104 of the fuel cell electric vehicle. The fuel cell electric vehicle 102 can include the battery 104 and a vehicle control unit 106. The vehicle control unit 106 can be configured to calculate a target battery current based on the state of charge of the battery 104, measure an actual battery current of the battery 104, determine a battery current error based on a difference between the target battery current and the actual battery current, and implement a performance derating for the fuel cell electric vehicle based on the battery current error. The system 100 can further include a fuel cell power plant 108 that can be in communication with the vehicle battery 104.

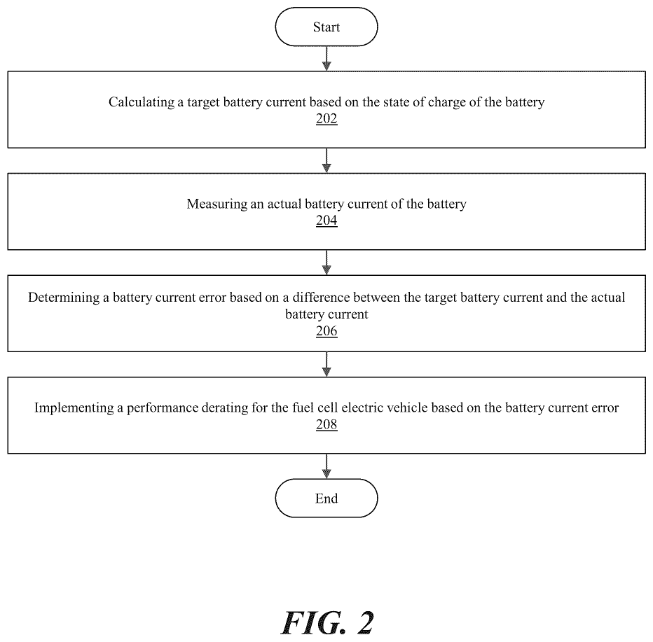

FIG. 2 illustrates a flowchart that describes a method 200 of adaptively derating an FCEV 102 based on the SOC. In certain embodiments, the method 200 can be performed by the system 100 described herein. In step 202, the method 200 can include calculating a target battery current based on the state of charge of the battery. At step 204, the method 200 can further include measuring an actual battery current of the battery 104. Then, at step 206, a battery current error can be determined based on a difference between the target battery current and the actual battery current. Then, at step 208, the method 200 can further include implementing a performance derating for the FCEV 102 based on the battery current error.

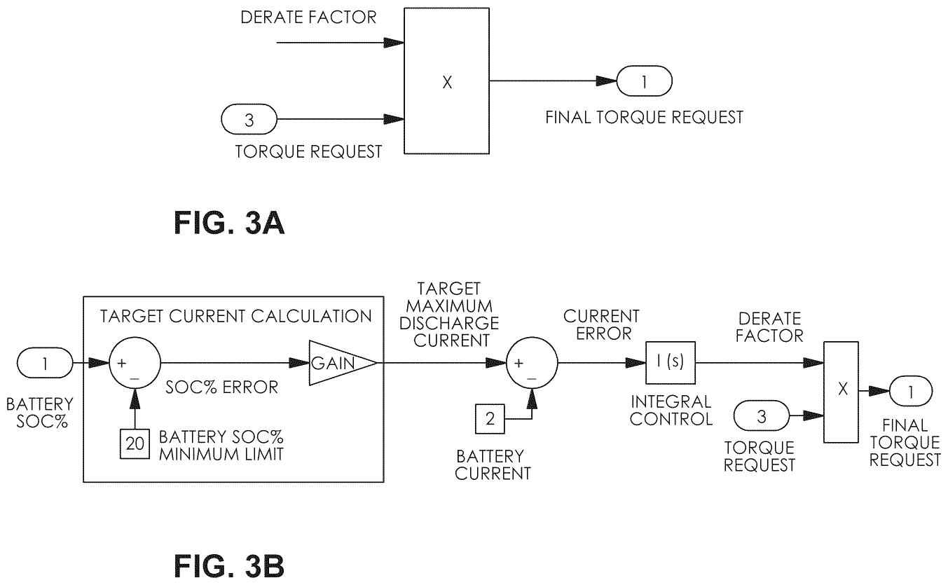

FIG. 3A illustrates a depiction of derating for a FCEV. A vehicle control system and software of the vehicle can provide a torque demand to a propulsion system of the vehicle, such as one or more electric motors. The static derating of this torque demand can be accomplished through a multiplicative factor. FIG. 3B illustrates a schematic describing the system using a adaptive derate factor based on the SOC according to the current technology. The target current calculation area can be implemented as a lookup table instead of an explicitly calculated error-based target. The integral control can be implemented using a number of different styles of feedback governors, such as described above, although an integral-only control can be sufficient.

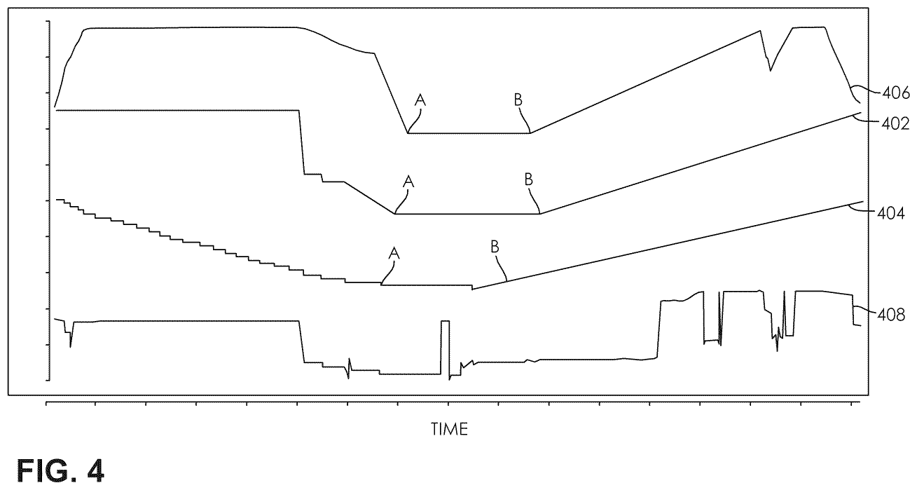

FIGS. 4-7 are graphical representations illustrating the effectiveness of the adaptive derating method 200 implemented by system 100 compared to a static derating or non-adaptive derating strategy. These graphical representations include a comparison of various measurements overtime.

FIG. 4 illustrates comparative data for a non-adaptive derating strategy where the derate factor is solely dependent on the state of charge of the battery. The graph displays several parameters through different lines that demonstrate the limitations of this approach. The graph includes line 402 which represents the derate factor (unitless, range 0-1), line 404 depicts the state of charge of the battery (percent charge, range from 0-100%), line 406 illustrates the speed of the vehicle (kilometer per hour, range 0-100 kph), and line 408 shows the discharge power available to the motor (kW, range 0 to 500), indicating the energy that could potentially be used for vehicle operation. At point A on the graph, the state of charge drops below an acceptable threshold. Due to the static nature of this derating strategy, the vehicle is forced to come to a complete stop. The vehicle remains in this stopped state until reaching point B, where the battery state of charge finally recovers to an acceptable level. This graphical representation demonstrates a fundamental limitation of non-adaptive derating strategies, where the derate factor depends solely on the state of charge. In such cases, the vehicle may be forced into a complete stop while waiting for SOC recovery, even when available power remains that could be utilized for maintaining some level of vehicle movement.

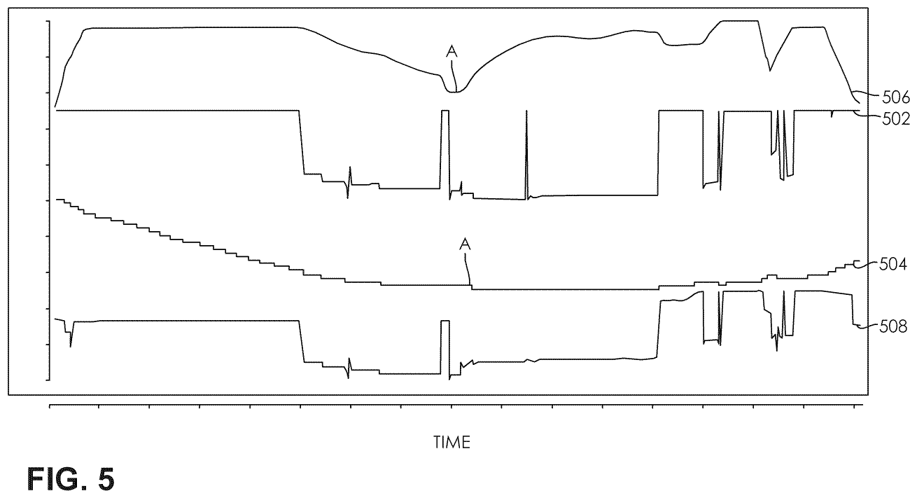

FIG. 5 illustrates the effectiveness of method 200 adaptive derating strategy, displaying the same parameters as FIG. 4 but with different operational outcomes. The graph tracks several parameters: line 502 representing the derate factor, line 504 showing the state of charge of the battery, line 506 depicting the vehicle speed, and line 508 illustrating the discharge power available to the motor. These parameters demonstrate how the adaptive derating approach maintains vehicle operability while protecting battery health. At point A on the graph, when the state of charge drops below a predetermined threshold, the system 100 implements the adaptive derating strategy of method 200. Instead of forcing a complete stop, the vehicle continues to operate at a reduced speed by implementing performance derating based on the battery current error. This adaptive approach allows the vehicle to maintain movement even when the state of charge is at an extreme low range where the fuel cell has half power. The graph demonstrates how system 100 feedback control enables the vehicle to continue operating by limiting power only as needed to maintain state of charge. As the fuel cell power increases, the vehicle speed can also increase, even while maintaining a low state of charge, showcasing the effectiveness of the adaptive derating method in preserving both vehicle drivability and battery health.

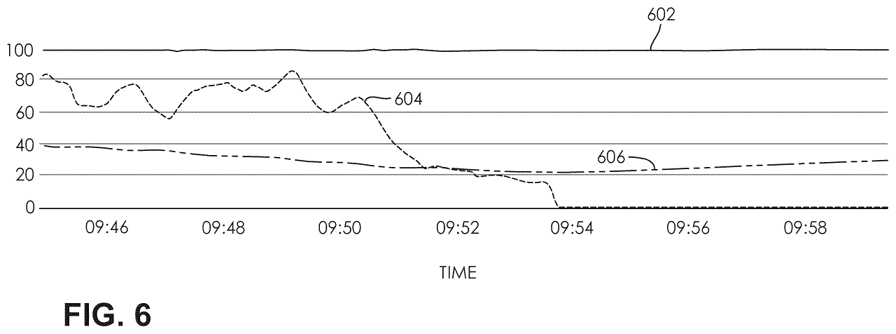

FIG. 6 illustrates data from a static derating method through three parameters: line 602 depicting the fuel cell power (kW), line 604 showing the vehicle speed (kilometers per hour), and line 606 representing the battery state of charge (percent charge, range 0-100%). The graph demonstrates a limitation of the static derating approach. When the battery state of charge drops below the acceptable threshold, the vehicle is forced to come to a complete stop and remain stationary while the battery recharges. This occurs despite the presence of 100 kW of available fuel cell power that could potentially be utilized for vehicle movement.

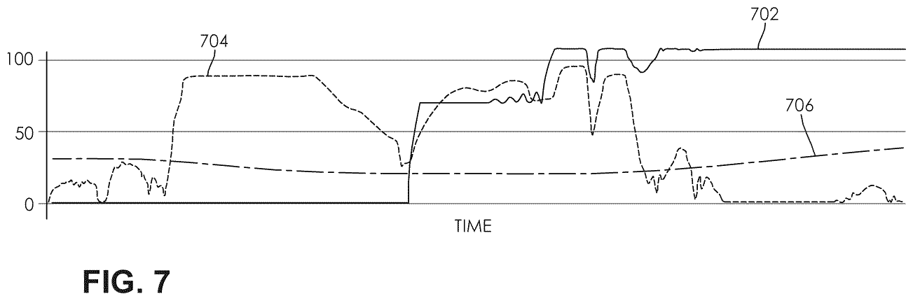

FIG. 7 illustrates the effectiveness of method 200 through three parameters: line 702 depicting the fuel cell power, line 704 showing the vehicle speed, and line 706 representing the battery state of charge. The graph demonstrates how the adaptive derating strategy enables continuous vehicle operation even under challenging conditions. When implementing method 200, the vehicle maintains a non-zero speed as the fuel cell power increases, despite the battery state of charge being at an extreme low range and the fuel cell operating at half power. The data shows that as the fuel cell transitions to full power, the vehicle speed continues to increase, even while the battery state of charge remains low. This demonstrates how the adaptive derating approach allows for improved vehicle performance without requiring complete battery recovery, effectively utilizing available power resources to maintain continuous operation.

Advantageously, the present technology includes implementing a adaptive derating method for fuel cell electric vehicles that maintains battery state of charge at or above a predetermined level while preserving vehicle drivability to the greatest extent possible. The adaptive approach allows for more efficient power management in FCEVs, particularly in heavy transport applications where vehicles may be loaded outside predetermined parameters in the normal course of use. By calculating a target battery current based on SOC, measuring actual battery current, determining battery current error, and implementing performance derating based on this error, the method can reduce available power only by an amount sufficient to maintain a target SOC, which results in less power reduction and quicker power return to the FCEV compared to static derating methods, effectively addressing the issue of potential vehicle stranding due to low battery SOC while maintaining minimum drivability.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of adaptively derating a fuel cell electric vehicle based on a state of charge of a battery of the fuel cell electric vehicle, comprising:
calculating a target battery current based on the state of charge of the battery;
measuring an actual battery current of the battery;
determining a battery current error based on a difference between the target battery current and the actual battery current; and
implementing a performance derating for the fuel cell electric vehicle based on the battery current error.

2. The method of claim 1, wherein the target battery current includes a linear function of the state of charge of the battery.

3. The method of claim 1, wherein the target battery current is calculated based on a lookup table.

4. The method of claim 1, wherein a feedback control is used to calculate the battery current error.

5. The method of claim 4, wherein the feedback control includes a proportional-integral-derivative (PID) controller.

6. The method of claim 4, wherein the feedback control comprises a sliding mode feedback control.

7. The method of claim 4, wherein the feedback control comprises an optimal feedback control.

8. The method of claim 4, wherein a control gain or gains is selected to achieve a desired state of charge profile as a minimum state of charge is reached.

9. The method of claim 1, wherein the performance derating is implemented using a unitless derate factor.

10. The method of claim 9, wherein the unitless derate factor is limited between zero and one.

11. The method of claim 10, wherein a maximum permitted tractive power is multiplied by the unitless derate factor to produce a final permitted tractive power.

12. The method of claim 10, wherein a tractive current is multiplied by the unitless derate factor to produce a final tractive current.

13. The method of claim 10, wherein a tractive torque is multiplied by the unitless derate factor to produce a final tractive torque.

14. The method of claim 1, further comprising applying a low-pass filtering to the actual battery current before determining the battery current error.

15. A system for adaptively derating a fuel cell electric vehicle based on a state of charge of a battery of the fuel cell electric vehicle, comprising:
the fuel cell electric vehicle including:
the battery; and
a vehicle control unit configured to:
calculate a target battery current based on the state of charge of the battery;
measure an actual battery current of the battery;
determine a battery current error based on a difference between the target battery current and the actual battery current; and
implement a performance derating for the fuel cell electric vehicle based on the battery current error.

16. The system of claim 15, wherein the performance derating is implemented using a unitless derate factor.

17. The system of claim 16, wherein the unitless derate factor is limited between zero and one.

18. The system of claim 17, wherein a maximum permitted tractive power is multiplied by the unitless derate factor to produce a final permitted tractive power.

19. The system of claim 17, wherein a tractive current is multiplied by the unitless derate factor to produce a final tractive current.

20. The system of claim 17, wherein a tractive torque is multiplied by the unitless derate factor to produce a final tractive torque.
